(19) United States
(12) Patent Application Publication
(10) Pub. No.: US 2009/0004911 A1
(43) Pub. Date: Jan. 1, 2009

(54) Power supply system

(75) Inventors: Akira Tsubaki, Susono (JP); Kentaro Shiraki, Susono (JP); Kei Ikeda, Susono (JP)

Correspondence Address: Edwards Angell Palmer & Dodge LLP, P.O. Box 55874, Boston, MA, 02205, US

(73) Assignee: Yazaki Corporation, Tokyo (JP)

(21) Appl. No.: 12/213,821

(22) Filed: Jun. 25, 2008

(30) Foreign Application Priority Data
Jun. 29, 2007 (JP) 2007-172855
Jan. 31, 2008 (JP) 2008-020513

(51) Int. Cl. H01R 13/72; H02G 3/04

(52) U.S. Cl. 439/501; 174/72 A

(57) ABSTRACT

For improving durability of a wiring harness of a power supply system used in a sliding structure, a power supply system 1 includes a casing 3; a wiring harness 2; a harness supporter 6 arranged so as to move freely back-and-forth in the casing 3; and a constant force spring 22. The wiring harness 2 is bent and wired along an outer surface of the harness supporter, and the harness supporter is biased with a spring force by the constant force spring so as to absorb a service length of the wiring harness. A spring unit 10 winding the constant force spring 22 around is arranged at the harness supporter 6. An end 22a′ of the constant force spring 22 pulled from the spring unit 10 is fixed at the casing 3. The constant force spring 22 is formed by winding a strip steel sheet spirally.

The priority application Number Japan Patent Applications 2007-172855 and 2008-020513 upon which this patent application is based is hereby incorporated by reference.

### BACKGROUND OF THE INVENTION

1. Field of the Invention

The present invention relates to a power supply system absorbing a service length of a wiring harness by using a spring for supplying continuously electric power, for example to a sliding door of a vehicle.

2. Description of the Related Art

In FIGS. 8A, 8B, an embodiment of a power supply system by prior art is shown (refer Patent Document 1: Japan Patent Application 2001-354085).

The power supply system fixed vertically in a sliding door 41 of a vehicle includes a protector (casing) 50 made of synthetic resin for receiving a wiring harness 43 to be bent freely, and a metallic flat spring 44 forcing the wiring harness 43 upwardly in the protector so as to absorb a service length of the wiring harness 43 by forcing the wiring harness toward a curved surrounding wall 54 along a vertical wall 53 of the protector 50 by a force of the flat spring 44.

The wiring harness 43 is wired from a long bottom opening 55 of the protector 50 through a traversing area 46 to a harness fixer 60 in the vicinity of a step 48 of a vehicle body 47 so as to swinging move freely back-and-forth in a front-rear direction of the vehicle. Electric wire portion 43a at one side of the wiring harness is led from a front side of the protector 50 to a side of the sliding door for continuously supplying power to an electric apparatus and an auxiliary apparatus at the side of the sliding door.

The protector 50 is structured by a protector base 51 and a protector cover 52. After mounting the wiring harness 43 and the flat spring 44 inside the protector 50, the protector base 51 and the protector cover 52 are locked and fixed with each other.

The flat spring 44 is fixed in a bottom area at a front-end of the protector 50 together with the wiring harness 43 (fixed portion of the flat spring is marked “59”). A plastic cap 49 is fixed at an end of the flat spring 44. The wiring harness 43 is supported slidably by the cap 49.

The wiring harness 43 is formed by covering a plurality of electric wires 43a with a plastic corrugate tube 43b. An end of the corrugate tube 43b is fixed with an adhesive tape in the bottom area at the front end of the protector 50. The corrugate tube 43b is formed by arranging alternately ribs and groves like bellows so as to have a good flexibility. The each electric wire 43a of the wiring harness 43 in the traversing area is safely protected by the corrugate tube 43b from interference with an outer side, water drops, and dust.

FIG. 8A shows the sliding door 41 in a complete close condition. FIG. 8B shows the sliding door 41 in a half-open condition nearing a full-open condition. When the sliding door 41 is in the complete close condition, the wiring harness 43 is pulled backwardly. When the sliding door 41 is in the full-open condition, the wiring harness 43 is pulled forwardly. When the sliding door 41 is in the half-open condition, the wiring harness 43 tends to droop downwardly, but the wiring harness 43 is forced upwardly by the flat spring 44, so that the service length of the wiring harness 43 is absorbed and catching of the wiring harness caused by drooping is prevented.

FIG. 9 shows another embodiment of the power supply system by prior art (refer a second Patent Document 2: Japan Patent Application 2006-50841).

The power supply system 61 for supplying power continuously to a sliding door or a sliding seat (not shown), which have a long sliding length, includes a long slim casing 62 having a long narrow first guide slit 63 and a long narrow second guide slit 67, a pulley 64 moving back and forth along the first guide slit 63, along compression spring 66 biasing the pulley 64 through a block 65 along the first guide slit 63, and a slider 68 moving back-and-forth along the second guide slit 67. One end 69a of the wiring harness 69 is fixed at the casing 62 and led to an outside of the casing 62. A middle area of the wiring harness 69 is formed into a U-shape along the pulley 64. The other end 69b of the wiring harness 69 is led to the outside of the casing 62 through the slider 68.

When the power supply system 61 is applied vertically at the sliding door, the one end 69a of the wiring harness to be at a fixed side is arranged at the sliding door and the other end 69b of the wiring harness to be at a movable side is arranged at a vehicle body. When the power supply system 61 is applied at the sliding seat, the power supply system 61 is arranged vertically or horizontally at a floor of the vehicle body, and the one side 69a of the wiring harness is arranged at the vehicle body, and the other end 69b of the wiring harness is arranged at the sliding seat.

A power supply system, which uses a compression spring formed into a wave-shape by bending a flat spring instead of the compression coil spring 66, similar as the power supply system shown in FIG. 9 is disclosed in Patent Reference 3: Japan Patent Application 2006-320145.

### SUMMARY OF THE INVENTION

### Objects to be Solved

When the power supply system 42 shown in FIGS. 8A, 8B is applied on a small vehicle, the protector (casing) 50 occupies a large area, so that flexibility of laying out the other auxiliary apparatuses is limited. In case that the sliding length of the sliding door 41 is large (i.e. the service length of the wiring harness is long), it appears that a height of the protector 50 increases.

When the power supply system 61 shown in FIG. 9 is applied on a sliding structure (the sliding door or the sliding seat) with a relatively small sliding length so as to shorten the casing 62 and the compression spring 66, changing of a spring force corresponding to deformation of the compression spring 66 becomes large. Thereby, an unexpected strong spring force generated at some positions of deformation of the compression spring 66 pushes strongly the wiring harness 69, and it may cause reducing durability of the wiring harness 69.

This strong spring force loads on the sliding structure and operating forces for opening and closing the sliding structure is increased, so that operatability of the vehicle may become worse. When trying to make the change of spring force of the compression spring for overcoming above problems, a whole length of the compression spring 66 must be extended. The extended compression spring 66 increases the casing 62 receiving the compression spring, thereby it will become difficult to apply the power supply system in a vehicle.

According to the above problems, an object of the present invention is to provide a power supply system, which can eliminate generation of an unexpected strong spring force during sliding operation of a sliding structure, and improve durability of a wiring harness pressed with the spring force and operability of the sliding structure, and additionally can miniaturize the sliding structure and can easily design a spring having a required spring force.

### How to Attain the Object of the Present Invention

In order to attain the object of the present invention, a power supply system is characterized in including a casing; a wiring harness; a harness supporter arranged so as to move freely back-and-forth in the casing; and a constant force spring, and in that the wiring harness is bent and wired along an outer surface of the harness supporter, and the harness supporter is biased with a spring force by the constant force spring so as to absorb a service length of the wiring harness.

According to the above structure, the harness supporter pushes the wiring harness with a constant force of the constant force spring so as to absorb a service length of the wiring harness. Thereby, there is no increase of the spring force caused by compression of a general compression spring, and the wiring harness is not pushed by an excessive force, so that the wiring harness is prevented from deformation and damage. When the power supply system is arranged at a sliding structure so as to lead the wiring harness from the power supply system to a stationary structure and the slide structure is slid to close against the spring force, operatability of closing the sliding structure is good because of the constant spring force. When the structure is let to open, operatability of opening the sliding structure is also good. The constant force spring has a very small change of the spring force.

The power supply system is more characterized in further including a spring unit, around which the constant force spring is wound, and in that the spring unit is arranged at the harness supporter and an end of the constant force spring led from the spring unit is fixed at the casing.

According to the above structure, a constant spring force in a direction of leading the end of the constant force spring from the spring unit and a constant restoring spring force in a direction of winding the constant force spring on the spring unit can be given. The harness supporter with the spring unit moves toward the end of the constant force spring in the casing by the restoring spring force to absorb the service length of the wiring harness. The spring unit can be arranged in the harness supporter to miniaturize a size of the power supply system. The end of the constant force spring can be fixed directly at the casing or through a connecting piece like a plate.

The power supply system is further characterized in that the constant force spring is formed by winding a strip-shape steel sheet.

According to the above structure, the constant force spring is wound and arranged in the casing, and partially led out to act the constant force to move the harness supporter for absorbing the service length of the wiring harness.

The power supply system is furthermore characterized in that the plural constant force springs are provided, and respective constant force springs separately wound at the harness supporter are arranged successively along a direction, in which the harness supporter moves freely back-and-forth in the casing, so as to be partially piled on each other.

According to the above structure, comparing with a case of using one constant force spring, in a case of using a plurality of constant force springs, assigning “n” for a number of the constant force springs, the constant force can be reduced to 1/n of the constant force in the case of using one spring by reducing a width of each constant force spring and each harness supporter to 1/n of the width in case of using one spring. Thereby, the power supply system can be miniaturized. When designing each width and each constant force of each constant force spring as same as that of one spring, the spring force can be increased to be “n” time of that of one spring with maintaining dimensions of the harness supporter.

The power supply system is further characterized in that the plural constant force springs are provided, and respective constant force springs are wound together at the harness supporter so as to be piled on each other.

According to the above structure, comparing with a case of using one constant force spring, in a case of using a plurality of constant force springs, assigning “n” for a number of the constant force springs, the constant force can be reduced to 1/n of the constant force in the case of using one spring by reducing a width of each constant force spring and each harness supporter to 1/n of the width and the length along the direction of moving the harness supporter in case of using one spring. Thereby, the power supply system can be more miniaturized. When designing each width and each constant force of each constant force spring as same as that of one spring, the spring force can be increased to be “n” time of that of one spring with maintaining dimensions of the harness supporter.

The power supply system is further characterized in that “n” is assigned for a number of the plural constant force springs, and each spring force for each of the plural constant force springs is designed with a 1/n value against the spring force required in a case of using only one constant force spring in the system, and each width of each of the plural constant force springs is designed with a 1/n value against a width of the only one constant force spring required in the case of using the only one constant force spring in the system.

According to the above structure, comparing with a case of using one constant force spring, in a case of using a plurality of constant force springs, the number of which “n” is assigned for, the width and the spring force of the constant force spring can be reduced to 1/n values in the case of using one spring. Thereby, the widths of the one constant force spring and the harness supporter can be miniaturized to 1/n values.

### Effects of Invention

According to the above structure, the harness supporter pushes the wiring harness with the constant force of the constant force spring so as to absorb a service length of the wiring harness. Thereby, there is no increase of the spring force caused by compression of the general compression spring, and the wiring harness is not pushed by the excessive force, so that the wiring harness is prevented from deformation and damage. When the power supply system is arranged at a sliding structure so as to lead the wiring harness from the power supply system to a stationary structure and the slide structure is slid to close against the spring force, operatability of closing the sliding structure is good because of the constant spring force. When the structure is let to open, operatability of opening the sliding structure is also good. The constant force spring has a very small change of the spring force.

According to the above structure, by using the spring unit winding the constant force spring around the spring unit, the size of structure can be miniaturized comparing with the side of the structure using general compression spring.

According to the above structure, the constant force spring led out like strip-shape generates a spring force enough to absorb the service length of the wiring harness. The constant force spring is led like a strip shape and generates the spring force, so that the size of the structure can be miniaturized comparing with that of the structure using the general compression spring.

According to the above structure, comparing with a case of using one constant force spring, in a case of using a plurality of constant force springs, assigning “n” for a number of the constant force springs, the constant force can be reduced to 1/n of the constant force in the case of using one spring by reducing a width of each constant force spring and each harness supporter to 1/n of the width in case of using one spring. Thereby, the power supply system can be miniaturized. When designing each width and each constant force of each constant force spring as same as that of one spring, the spring force can be increased to be “n” time of that of one spring with maintaining dimensions of the harness supporter.

According to the above structure, comparing with a case of using one constant force spring, in a case of using a plurality of constant force springs, the number of which “n” is assigned for, the width and the spring force of the constant force spring can be reduced to 1/n values in the case of using one spring. Thereby, the widths of the one constant force spring and the harness supporter can be miniaturized to 1/n values. The power supply system including the casing can be miniaturized.

The above and other objects and features of this invention will become more apparent from the following description taken in conjunction with the accompanying drawings.

### BRIEF DESCRIPTION OF THE DRAWINGS

FIG. 1 is a perspective view of an embodiment of a power supply system according to the present invention;

FIG. 2 is a perspective view of the power supply system shown in FIG. 1 absorbing a service length of a wiring harness;

FIG. 3 is a perspective view of an embodiment of a constant force spring unit;

FIG. 4 is a perspective view of drooping of the wiring harness of the power supply system shown in FIG. 1;

FIG. 5A is a front view of an embodiment of a harness supporter of the power supply system shown in FIG. 1;

FIG. 5B is a horizontal cross-sectional view of the harness supporter shown in FIG. 5A;

FIG. 6A is a front view of another embodiment of the harness supporter of the power supply system shown in FIG. 1;

FIG. 6B is a horizontal cross-sectional view of the harness supporter shown in FIG. 6A;

FIG. 7A is a front view of other embodiment of a harness supporter of the power supply system shown in FIG. 1;

FIG. 7B is a horizontal cross-sectional view of the harness supporter shown in FIG. 7A;

FIG. 8A is a perspective view of an embodiment of a power supply system by prior art;

FIG. 8B is a perspective view of the power supply system by prior art in a different condition from a condition shown in FIG. 8A; and

FIG. 9 is a perspective view of another embodiment of a power supply system by prior art.

### DESCRIPTION OF THE PREFERRED EMBODIMENT

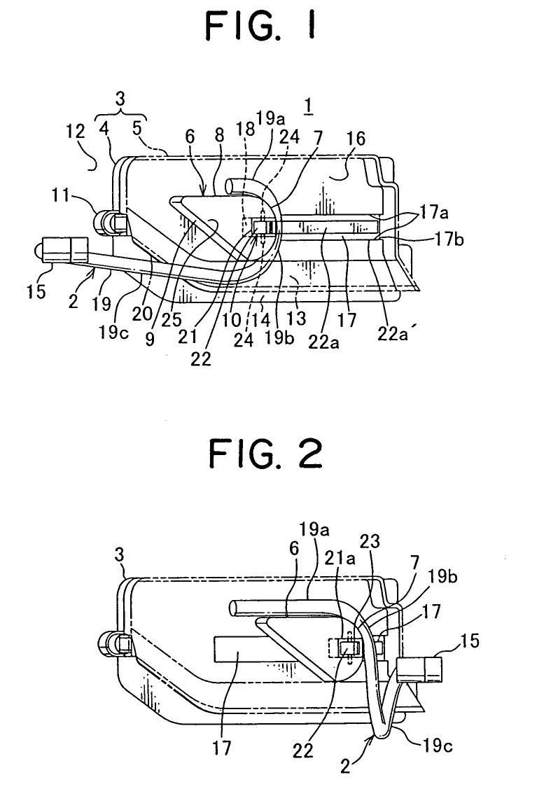

FIGS. 1, 2 show an embodiment of a power supply system according to the present invention.

The power supply system 1 includes a plastic casing 3, a wiring harness 2 bent and arranged movably in the casing 3, a harness supporter 6 having a curved surface 7 providing the wiring harness 2 thereon and being arranged so as to move freely back-and-forth in the casing 3, and a constant force spring unit biasing the harness support unit 6 so as to absorb a service length of the wiring harness.

The casing 3 is formed with a base 4 and a cover 5 (shown with a two-dot chain line). The base 4 and the cover 5 are fixed to each other by a lock device (not shown). The base 4 is fixed by a bracket 11 on a door inner panel 12 of a sliding door of a vehicle. A bottom end portion of the cover 5 is curved toward an inside of vehicle. Along bottom opening 14 is provided between an inside of a curved portion 13 and the base 4. The wiring harness 2 is led from the bottom opening 14 toward a harness lock 15 at a vehicle body so as to move freely back-and-forth.

A guide groove 17 as a guide rail is provided horizontally in a central area in a vertical direction of a vertical base plate 16 of the base 4. A slider 18 of the harness supporter 6 engages slidably with the guide groove 17. The guide groove 17 is formed from a front end of the base plate 16 to a middle point in a lengthwise direction of the base plate 16. The guide groove 17 has a recess (not shown) respectively at upper and lower edges 17a. Upper and lower ends of the slider 18 engage slidably with the recesses.

The slider 18 is formed into a rectangular plate shape, and inserted from a front end 17b into the guide groove 17. At upper and lower ends of the slider 18, rollers (not shown) for sliding can be arranged. The slider 18 is arranged integrally or separately to project from a rear surface of the harness supporter 6. The rear surface of the harness supporter 6 slides freely on the base plate 16 of the base 4.

The harness supporter 6 is a plate having a thickness same as an outer diameter of a corrugate tube 19 of the wiring harness 2. At a front end of the harness supporter 6, the curved surface 7 is formed into a half circular shape. A top end of the curved surface 7 continues to an upper horizontal straight surface 8 of the harness supporter 6. A bottom end of the curved surface 7 continues to a lower upward-slant surface 9 of the harness supporter 6. The straight surface 8 and the slant surface 9 intersect to each other at a rear end.

An upper portion 19a of the wing harness 2 is arranged along the straight surface 8 at the upper side of the harness supporter 6, and fixed by a fixing device like a adhesive tape or a wire band at a narrow opening (not shown) at a rear side of the casing 3, and wired along the door inner panel 12 so as to be connected to an auxiliary device (not shown) at the sliding door by a connector.

As shown in FIG. 1, the wiring harness 2 is bent into a U-shape along the curved surface 7 at the front side of the harness supporter 6. The upper portion 19a of the wiring harness 2 at a fix side continues through a harness bend portion 19b to a lower portion 19c. As shown in FIGS. 1, 2, the lower portion 19c moves freely back-and-forth along the bottom opening 14 of the casing 3 between the sliding door and the harness lock 15 at the vehicle body side. The lower portion of the wiring harness 2 is connected through the harness lock 15 to a vehicle-body side wiring harness (not shown). The lower slant surface 9 of the harness supporter 6 corresponds to an upward slant 20 at a rear bottom side of the casing 3.

A rectangular opening 21 is provided at the front portion of the harness supporter 6 to penetrate in a direction of a thickness of the harness supporter 6. The spring unit 10 is located in the opening 21. A strip-shape straight portion 22a of the constant force spring 22 led forwardly out from the spring unit 10 is arranged along a bottom surface (the surface of the base plate 16). A top end 22a′ of the straight portion 22a is fixed at a front side 17b of the guide groove 17 on the bottom surface by a fixing device (not shown) like a screw or a hook. The constant force spring in the embodiment is a spiral spring by winding a strip steel sheet spirally. The constant force spring has a very small force change.

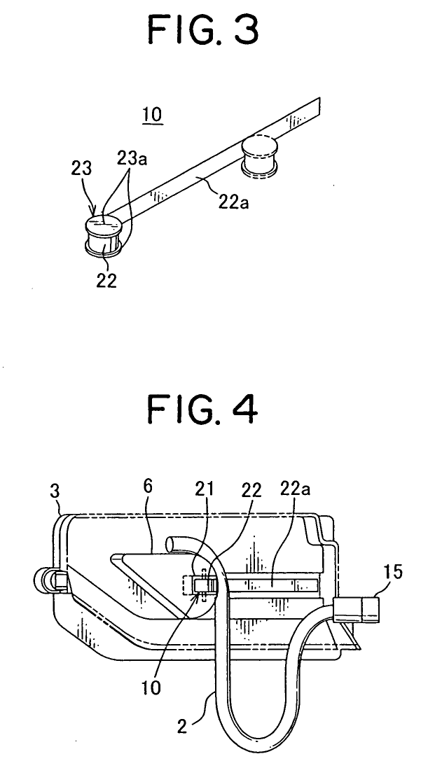

An embodiment of the spring unit 10 is shown in FIG. 3. The spring unit 10 includes a plastic reel 23 and a metallic constant force spring 22 wound around the reel 23. The reel is formed with upper and lower disks 23a, and a shaft (not shown) perpendicular to the disks 23a and connecting the disks 23a.

A base end of the constant force spring 22 is mounted on the shaft of the reel 23 so as to wind the constant force spring 22 spirally around the shaft. The constant force spring 22 tends to be restored into the spiral shape by own elastic restoring force. The constant force spring 22 is led in a strip shape from the reel 23 against the elastic restoring force.

A solid line in FIG. 3 shows the constant force spring 22, the straight portion of which is pulled long. A two-dot chain line in FIG. 3 shows the constant force spring 22, the straight portion of which is pulled short. The constant force spring 22 has a substantially constant elastic force for any pulled length. In the both cases of pulled-long and pulled-short, the restoring force is always constant. The force pulling the constant force spring 22 in an initial condition from the reel 23 and the force further pulling the constant force spring 22 in the pulled-short condition are substantially same.

As shown in FIG. 1, upper and lower pivots 24 are integrally or separately formed projectingly and coaxially from the upper and lower disks 23. The upper and lower pivots 24 are supported rotatably by horizontal upper and lower inner walls 21a (FIG. 2) in the opening 21 of the harness supporter 6. The harness supporter 6 includes a vertical front wall 25 and upper and lower bearings (not shown) near the opening 21. The pivots 24 are supported rotatably in the bearings.

When an outer diameter of the spring unit 10 is formed larger than a thickness of the harness supporter 6, the spring unit 10 can slightly project from the opening 21 of the harness supporter 6 toward the cover 5 of the protector 3. A part of outer surface of the reel 23 (FIG. 3) of the spring unit 10 can be positioned in the guide groove 17 at the base 4 of the protector 3. A slider 18 is arranged at a rear side of the opening 21. The constant force spring 22 to be pulled is located slider 18 at a front side of the slider 18 in the guide groove 17. The thickness of the constant force spring 22 can be received in the power supply system 1 to be made thinner. The harness supporter 6 and the slider 18 can slide smoothly.

In the embodiment, the wiring harness 2 is structured by covering the plurality of covered electric wires (not shown) with the corrugate tube 19 having oval or round cross-section. Instead of the corrugate tube 19, a meshed tube (not shown) can be used or, eliminating the protection tube, the plurality of electric wires can be bundled partially.

Hereafter, actions of the power supply system 1 will be described with reference to FIGS. 1-3.

In FIG. 1, the sliding door at a left side of the vehicle is slid to a full-open condition. The harness supporter 6 is positioned at a rear side of the guide groove 17, and the constant force spring 22 is pulled long partially like a strip shape. The wiring harness 2 is bent along the curved surface 7 at the front end of the harness supporter 6, and extends straightly toward the harness lock 15 at the vehicle body.

When the sliding door is slid rearward from the complete-close position to the open position and in a middle way in a half-open position, the wiring harness 2 tends to droop as shown in FIG. 4. The harness supporter 6 moves slidingly along the guide groove 17 as shown in FIG. 2 by the restoring force of the extended constant force spring 22 restoring to a spiral shape. Thereby, the wiring harness 2 is pushed along the curved surface 7 so as to absorb the service length. In FIG. 1, the wiring harness 2 is pulled forward in the casing 3 by the constant force spring 22.

In the half-open condition of the sliding door, the harness supporter 6 is positioned in a middle area in a lengthwise direction of the guide groove 17. When the sliding door moves further to the open position, the harness supporter 6 is positioned by the spring force of the constant force spring 22 so as to absorb the service length by an action of opening the sliding door. So, the spring force to absorb the service length maybe substantially constant. It is suitable to use the constant force spring 22 for it. When the sliding door move from the full-open position to the complete close position, the similar actions are provided.

The sliding door in the full-open condition is shown in FIG. 2. The harness supporter 6 is positioned at the front end of the guide groove 17, and the constant force spring 22 is almost wound in the reel 23 so as to project short forward. Winding action of the constant force spring 22 is naturally performed by own restoring force. The constant force spring 22 has spring force to move the harness supporter 6 against a self-weight of the wiring harness 2.

The spring force of the constant force spring 22 between the complete close position in FIG. 1 and the full open position in FIG. 2 is substantially constant. Thereby, the operating force for opening the sliding door is almost constant. When automatic sliding door is applied, a driving motor (not shown) is required a small power and the motor driving can be miniaturized. The bend portion 19b of the wiring harness 2 is pushed forward with the constant force by the curved surface 7 of the harness supporter 6, so that the wiring harness 2 is prevented from an excessive large force and deformation and damage.

From the full-open position in FIG. 2 to the complete close position in FIG. 1 of the sliding door, the spring force of the constant force spring 22 is constant. Thereby, operating force of closing the sliding door is almost constant, so that the operatability is good. When automatic sliding door is applied, a driving motor is required a small power and the motor driving can be miniaturized. The bend portion 19b of the wiring harness 2 is pushed rearward with the constant force by the curved surface 7 of the harness supporter 6, so that the wiring harness 2 is prevented from an excessive large force and deformation and damage.

In the embodiment, the reel 23 is used in the spring unit 10. Eliminating the reel 23, the constant force spring 22 can be received spirally in the casing 3 so as to fix the spring unit 10 in the opening 21 of the harness supporter 6 and pull the end of the constant force spring 22 through a slit (not shown) of the spring unit 10.

In the above embodiment, the harness supporter 6 is formed into a U-shape. The harness supporter 6 can be formed into another shape, for example a round shape, a semicircle shape or a semicircle front half and rectangular rear half shape. An round outer surface can be designed a rotatably pulley.

In the above embodiment, the power supply system 1 is applied for a sliding door of a vehicle. The power supply system 1 can be also applied to a sliding door of other vehicle or other apparatus. The power supply system also can be applied to a sliding seat of the vehicle.

When the power supply system is applied to the sliding seat, the casing 3 is placed horizontally on a floor (not shown) of the vehicle body, the upper portion 19a of the wiring harness 2 is connected to the wiring harness (not shown) at the vehicle body, the lower portion 19c of the wiring harness 2 is connected to the auxiliary device at the sliding seat.

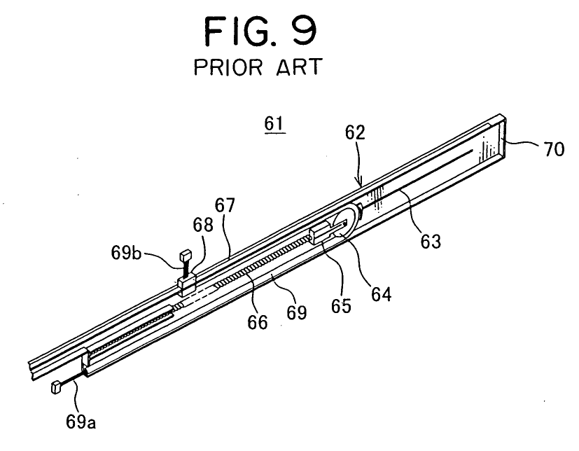

The long opening 14 of the casing 3 is provided at the base plate of the cover 5. The slider 68 is engaged slidably with the long opening 67 as shown in FIG. 9 as prior art, and the lower portion 19c is led out from the slider 68. When the casing 3 is arranged vertically, inverting the power supply system 1 in FIG. 1 up-side-down, a long opening 67 is arranged at a narrow top wall of the casing 3 as shown in FIG. 9, and the slider 68 is engaged with the opening 67 and the lower portion 19c of the wiring harness 2 is led out from the slider 68.

The prior art shown in FIG. 9 can use the constant force spring 22 instead of the compression spring 66 so as to fix the spring unit 10 at the block 65 in FIG. 9 and lead the end of the constant force spring 22 like a strip from the spring unit 10 toward the front wall 70 of the casing 62 in a counter direction of the compression coil spring 66.

In the above embodiment in FIG. 1, the spring unit 10 is mounted at the harness supporter 6. The spring unit 10 can be fixed at the front end of the casing 3 so as to pull the constant force spring 22 rearward from the spring unit 10 to the harness supporter 6 at the rear side and fix the end 22a′ of the constant force spring 22 at the harness supporter 6.

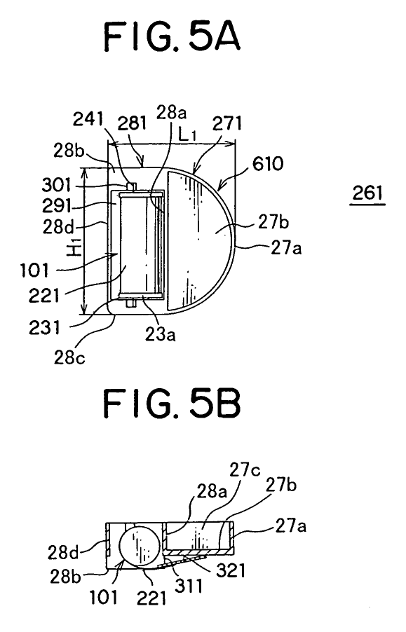

FIGS. 5-7 show another embodiments of changing the harness supporter 6 and the constant force spring 22 (spring unit 10) in the power supply system in FIG. 1. Each constant force spring 221-223 assembled in respective spring unit 101-103 is mounted in each harness supporter 610-630. Each harness supporter 610-630 and each spring unit 101-103 forms an absorbing unit 261-263 of the power supply system 1.

In the absorbing unit 261 shown in FIGS. 5A, 5B, the harness supporter 610 is formed into a U-shape, and a width of the constant force spring 221 is designed slightly smaller than a width H1 of the harness supporter 610.

The harness supporter 610 is structured with a half-circular front half portion 271 and a rectangular rear half portion 281. The front half portion 271 has a circular curved outer side wall 27a and a rear wall 27b continued and perpendicular to an edge of the outer side wall 27a. The outer side wall 27a and the rear wall 27b continue to a middle side wall 28a of a rectangular box portion 281. A space 27c is formed with the middle side wall 28a, the outer side wall 27a and the rear wall 27b.

As similar as the embodiment shown in FIG. 1, the wiring harness 2 is bent and curved into a U-shape along the outer side wall 27a of the front half portion 271. The upper and lower portions 19a and 19c continued to the bend portion 19b (shown in FIG. 1) are arranged along upper and lower side walls 28b, 28c of the rear half portion 281.

The rear half portion 281 includes a rectangular through space 291 surrounded by the middle side wall 28a, a rear side wall 28d and the thick upper and lower side walls 28b, 28c. The spring unit 101 is received in the through space 291. The upper and lower side walls 28b, 28c are taller than the middle side wall 28a and the rear sidewall 28d. The spring unit 101 is received within a wall height of the upper and lower side walls 28b, 28c. Sliders (not shown) engaged with the guide groove 17 of the casing 3 in FIG. 1 are provided at the upper and lower side walls 28b, 28c. Grooves 301 for receiving upper and lower pivots 241 of the spring unit 101 are provided at the upper and lower side walls 28b, 28c.

The pivots 241 project outwardly from the centers of the upper and lower disks 23a of the reel 231. The base end (not shown) of the constant force spring 221 is supported at the shaft (not shown) connecting the both disks 23a. Instead of the shaft, by extending the base end of the constant force spring 221 in both upward and downward directions to be supported at inner sides of the upper and lower side walls 28b, 28c.

An opening 311 is arranged at a front side of extensions of the upper and lower side walls 28b, 28c in a same vertical plane of the middle side wall 28a of the rectangular rear half portion 281. The constant force spring 211 is pulled against the spring force forwardly from the opening 311 along the rear wall 27b. A plate 321 is fixed with screws at the top end of the constant force spring 221 on a rear surface of the base plate 321. The plate 321 is fixed by heat welding at the front end of the guide groove 17 of the base plate 16 of the casing 3 in FIG. 1.

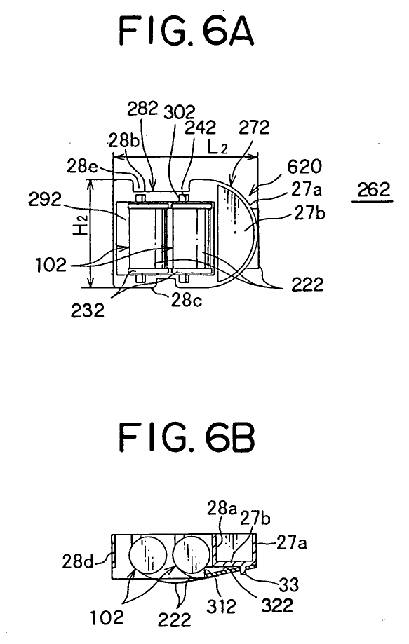

For miniaturize a height H1 of the harness supporter 610 in FIG. 5, an absorbing unit 262 shown in FIGS. 6A, 6B has two spring units 102, each of which includes a constant force spring 222 having a half width of the constant force spring 221 in FIG. 5, arranged successively along a moving direction. Two constant force springs 222 are used in parallel, so that total spring force will be same as the spring force of the constant spring force 221 in FIG. 5.

Each spring unit 102 has a diameter of a reel 232 and a diameter of the constant force spring 222 same as that of the reel 231 and the spring 221 in FIG. 5.

The harness supporter 620 is formed with a half-circular front half portion 272 and a rectangular rear half portion 282. The front half portion 272 has a side wall 28a and a rear wall 27b. The rear half portion 282 has a through space 292 for receiving the spring unit 102. Heights of upper and lower side walls 28b, 28c are larger than that of front and rear side walls 28a, 28d of the space 292. Two constant force springs 222 to be interposed on each other are pulled forwardly. The harness supporter 620 has similar basic structure as shown in FIG. 5. At the upper and lower side walls 28b, 28c, grooves 302 receiving pivots 242 of the each reel 232 are provided. Each spring unit 102 is received within the heights of the upper and lower side walls 28b, 28c in the space 292.

In the embodiment shown in FIG. 6, upper and lower recesses 28e are formed in a middle area of the rear half portion 282 so as to arrange the wiring harness 2 along the front half portion and upper and lower surfaces with a small contact surface. At the rear half portion, a slider (not shown) engaging with the guide groove 17 shown in FIG. 1 is provided. The plate 322 is fixed at top ends of two constant force springs 222. A projection 33 for temporarily holding a hole of the plate 322 is provided on the rear wall 27b of the front half portion 272. When the absorbing unit 262 is assembled in the casing 3 (FIG. 1), by removing the plate 322 from the projection 33 and pulling the constant force springs 222, the plate 322 is fixed on the base plate 16 (FIG. 1).

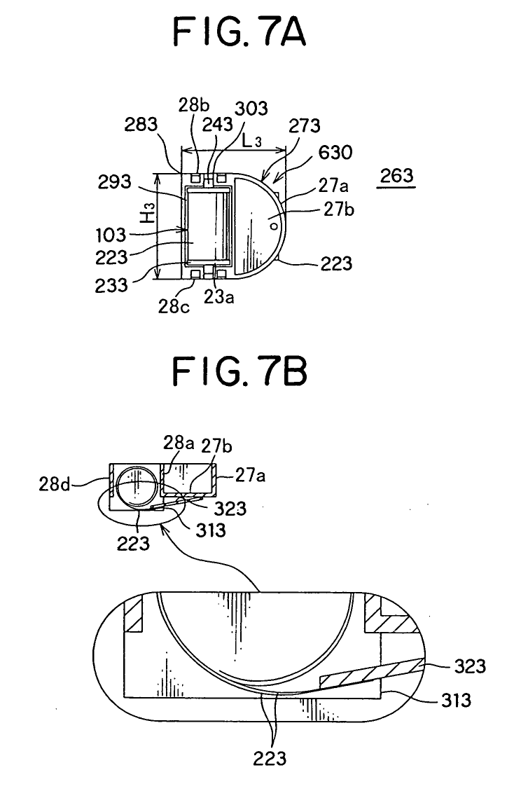

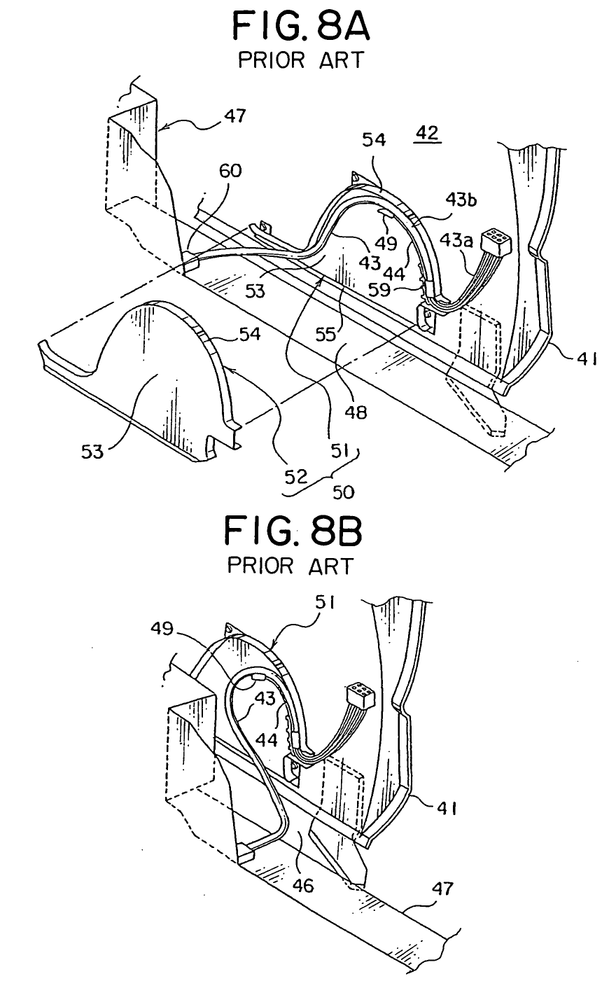

A length L2 of the harness supporter 620 in FIG. 6A is same or slightly longer than the length L1 of the harness supporter 610 in FIG. 5A. A length L3 of the harness supporter 630 in FIG. 7A can be shorter than the length L2 of the harness supporter 620 by winding two constant force springs 223 interposingly in a thickness direction around the reel 233.

The harness supporter 630 has a basic structure same as the embodiment in FIG. 5A. The harness supporter 630 includes a half circular front half portion 273 and a rectangular rear half portion 283. The rear half portion 283 has a through space 293 for receiving a spring unit 103. Upper and lower side walls 28b, 28c are provided with grooves 303 for receiving pivots 243 at outer sides of the reel 233 and a slider (not shown) engaging with the groove guide 17 in FIG. 1. The spring unit 103 is received within the heights of the upper and lower side walls 28b, 28c.

The side wall 27a and the rear wall 27b of the front half portion 273 continue to a middle side wall 28a of the rear half portion 283. The middle side wall 28a and the rear side wall 28d correspond to each other in parallel. Two constant force springs 223 are pulled from an opening 313 on the same vertical plane of the middle side wall 28a. Ends of the two constant force springs 233 are fixed on a rear surface of a plate 323. The plate 323 is held temporarily at the rear wall 27b. The tow constant force springs are pulled smoothly from the opening 313.

Base ends (not shown) of the two constant force springs 223 are held at a shaft (not shown) of the reel 233 or at inner surfaces of the disks 23a of the reel 233. According to the embodiment shown in FIGS. 7A, 7B, both of the height and the length of the absorbing unit can be miniaturized comparing with the absorbing unit 261 in FIGS. 5A, 5B.

In the embodiment in FIGS. 6A, 6B, when the rectangular space 292 for receiving each reel 232 is extended into an inside of the half circular front half portion 620, the length of the harness supporter 620 can be same or less than that of the harness supporter 610 in FIGS. 5A, 5B.

In each embodiment of FIGS. 5A, 5B, 6A, 6B, 7A and 7B, the rear wall 27b of the harness supporter 610-630 is positioned along the base plate 16 of the base 4 of the casing 3 in FIG. 1; and the end of the constant force spring 221-223 is through between the base plate 16 and the rear wall 27b and fixed at the front end of the base 4 (FIG. 1). The slider corresponding to the slider 18 of the supporter 6 in FIG. 1 is arranged at the rectangular rear half portion 281-283 of the harness supporter 610-630.

By applying the absorbing unit 262 in FIGS. 6A, 6B, the casing 3 in FIG. 1 can be miniaturized in a height direction. By applying the absorbing unit 262 in FIGS. 7A, 7B, the casing 3 in FIG. 1 can be miniaturized in a height direction and a length direction.

The embodiment in FIGS. 6A, 6B uses two constant force springs 222 and the two reels 232 are arranged successively in the front-rear direction. Three or more constant force springs 222 can be used. When a number of the constant force springs is “n”, a width of each constant force spring 222 may be 1/n of the width of the constant force spring 221 in FIGS. 5A, 5B, and a spring force of each constant force spring 222 may be 1/n of the spring force of the constant force spring 221 in FIGS. 5A, 5B.

The embodiment in FIGS. 7A, 7B uses two constant force springs 223 wound interposingly on a reel 233. Three or more constant force springs 223 wound on the reel 233 can be used. When a number of the constant force springs is “n”, a width of each constant force spring 222 may be 1/n of the width of the constant force spring 221 in FIGS. 5A, 5B, and a spring force of each constant force spring 222 may be 1/n of the spring force of the constant force spring 221 in FIGS. 5A, 5B.

Instead of the reel 231-233 having the upper and lower disks 23a in FIGS. 5A, 5B, 6A, 6B, 7A, 7B, a reel (not shown) having inner shafts (not shown) and outer pivots 241-243 can be used.

The embodiments in FIGS. 6A, 6B, 7A, 7B uses two constant force springs 222, 223 having shorter width than that of the constant force spring of the embodiment in FIGS. 5A, 5B for miniaturizing the harness supporter. In the embodiment in FIGS. 6A, 6B, 7A, 7B, the two or more constant force springs 222, 223 having the width same as the constant force spring of the embodiment in FIGS. 5A, 5B can be used for enlarging the spring force.

What is claimed is:

1. A power supply system, comprising:
a casing;
a wiring harness;
a harness supporter arranged so as to move freely back-and-forth in the casing; and
a constant force spring,
Wherein the wiring harness is bent and wired along an outer surface of the harness supporter,
wherein the harness supporter is biased with a spring force by the constant force spring so as to absorb a service length of the wiring harness.

2. The power supply system according to claim 1, wherein the constant force spring is formed by winding a strip-shape steel sheet.

3. The power supply system according to claim 2, further comprising a spring unit, around which the constant force spring is wound, wherein the spring unit is arranged at the harness supporter and an end of the constant force spring led from the spring unit is fixed at the casing.

4. The power supply system according to claim 2, wherein the plural constant force springs are provided, and respective constant force springs separately wound at the harness supporter are arranged successively along a direction, in which the harness supporter moves freely back-and-forth in the casing, so as to be partially piled on each other.

5. The power supply system according to claim 2, wherein the plural constant force springs are provided, and respective constant force springs are wound together at the harness supporter so as to be piled on each other.

6. The power supply system according to claim 4, wherein “n” is assigned for a number of the plural constant force springs, and each spring force for each of the plural constant force springs is designed with a 1/n value against the spring force required in a case of using only one constant force spring in the system, and each width of each of the plural constant force springs is designed with a 1/n value against a width of the only one constant force spring required in the case of using the only one constant force spring in the system.

7. The power supply system according to claim 3, wherein the plural constant force springs are provided, and respective constant force springs separately wound at the harness supporter are arranged successively along a direction, in which the harness supporter moves freely back-and-forth in the casing, so as to be partially piled on each other.

8. The power supply system according to claim 3, wherein the plural constant force springs are provided, and respective constant force springs are wound together at the harness supporter so as to be piled on each other.

9. The power supply system according to claim 5, wherein “n” is assigned for a number of the plural constant force springs, and each spring force for each of the plural constant force springs is designed with a 1/n value against the spring force required in a case of using only one constant force spring in the system, and each width of each of the plural constant force springs is designed with a 1/n value against a width of the only one constant force spring required in the case of using the only one constant force spring in the system.

10. The power supply system according to claim 7, wherein “n” is assigned for a number of the plural constant force springs, and each spring force for each of the plural constant force springs is designed with a 1/n value against the spring force required in a case of using only one constant force spring in the system, and each width of each of the plural constant force springs is designed with a 1/n value against a width of the only one constant force spring required in the case of using the only one constant force spring in the system.

11. The power supply system according to claim 8, wherein “n” is assigned for a number of the plural constant force springs, and each spring force for each of the plural constant force springs is designed with a 1/n value against the spring force required in a case of using only one constant force spring in the system, and each width of each of the plural constant force springs is designed with a 1/n value against a width of the only one constant force spring required in the case of using the only one constant force spring in the system.
